(19) United States
(12) Patent Application Publication
(10) Pub. No.: US 2007/0237415 A1
(43) Pub. Date: Oct. 11, 2007

(54) Local Processing (LP) of regions of arbitrary shape in images including LP based image capture

(76) Inventors: Gary X. Cao, Santa Clara, CA (US); George Chen, Los Gatos, CA (US)

Correspondence Address: SCHWABE, WILLIAMSON & WYATT, P.C., PACWEST CENTER, SUITE 1900, 1211 S.W. FIFTH AVE., PORTLAND, OR, 97204, US

(21) Appl. No.: 11/392,203

(22) Filed: Mar. 28, 2006

(51) Int. Cl. G06K 9/40

(52) U.S. Cl. 382/254

(57) ABSTRACT

Various embodiments of methods, apparatuses, articles of manufacture, and systems for determining one or more regions of one or more images for modification to remove information, through application of one or more criteria to the one or more images, selecting one or more modifications to be made to the one or more determined regions of the one or more images to remove information, the one or more modifications associated with at least one of the one or more criteria, and locally modifying the one or more regions of the one or more images in accordance with the selected one or more modifications to remove information, are described herein. In other embodiments, a plurality of the images taken under different conditions may be combined to form a composite image.

### TECHNICAL FIELD

Embodiments relate to the field of image processing, in particular, to methods and apparatuses for locally processing regions of arbitrary shape of one or more images, including Critical Dimension Scanning Electron Microscope (CD-SEM) images.

### BACKGROUND

Along with advances being made in computing technology, significant advancements have been achieved in the field of image processing. Today, image processing, including sophisticated image enhancement techniques, are being employed in a wild range of applications, from commercial photography, medical imaging, satellite imaging to space photography, to name just a few.

In particular, continuous advancements in integrated circuits and microelectromecanical devices have given rise to a number of different metrology systems used to measure different nano- and micro-scale features of the circuits and devices, one prominent metrology technique using Critical Dimension Scanning Electron Microscope (CD-SEM) systems. A CD-SEM system may include a scanning electron microscope and one or more computing devices which acquire the image from the microscope and measure one or more features of the image. The features or portions thereof captured by the microscope in images may range in size from a few nanometers to a few microns. They result from scanning an electron beam across the features of the circuit or device that are of interest. Occasionally however, certain portions of the image may also contain bright or dark spots or other noise or flaws caused by, for example, conductive elements of the circuit or device interacting with the scanning electron beam employed to create the image, or residuals of etching and cleaning processes.

Existing CD-SEM systems, like most conventional imaging systems, typically provide only global remedies to these image flaws. The system may, automatically or at user direction, adjust the brightness or contrast of the entire image. Local processing of only the flawed portion, by adjusting only its brightness or contrast, replacing the flawed portion, or filtering it against a known, healthy image is not available in prior art CD-SEM systems. Further, as the features captured in images become increasingly small, such flaws pose increasing problems for obtaining accurate measurements.

### BRIEF DESCRIPTION OF THE DRAWINGS

Embodiments of the present invention will be described by way of exemplary embodiments, but not limitations, illustrated in the accompanying drawings in which like references denote similar elements, and in which:

FIG. 1 illustrates modules in various embodiments of the present invention;

FIG. 2 illustrates an exemplary image suitable for use by various embodiments of the present invention, as well as a plurality of regions of that image;

FIGS. 3a-3e illustrate exemplary brightness and contrast modifications performed on selected regions of an image by various embodiments of the present invention;

FIG. 4 illustrates an exemplary content replacement modification performed on selected regions of an image by various embodiments of the present invention;

FIG. 5 illustrates an exemplary content filtering modification performed on selected regions of an image by various embodiments of the present invention;

FIG. 6 illustrates a flow chart view of selected operations of the methods of various embodiments of the present invention;

FIG. 7 illustrates a CD-SEM system view of embodiments of the present invention; and

FIG. 8 illustrates an example computer system suitable for use to practice selected aspects of various embodiments of the present invention.

### DETAILED DESCRIPTION OF ILLUSTRATIVE EMBODIMENTS

Illustrative embodiments of the present invention include, but are not limited to, methods and apparatuses for determining one or more regions of one or more images for modification to remove information, through application of one or more criteria to the one or more images, selecting one or more modifications to be made to the one or more determined regions of the one or more images to remove information, the one or more modifications associated with at least one of the one or more criteria, and locally modifying the one or more regions of the one or more images in accordance with the selected one or more modifications to remove information. In other embodiments, a plurality of the images taken under different conditions may be combined to form a composite image.

Various aspects of the illustrative embodiments will be described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features are omitted or simplified in order not to obscure the illustrative embodiments.

In particular, embodiments of the present invention will be described in the context of electron microscopy or CD-SEM systems, however, the embodiments are not so limited. Embodiments of the present invention may be practiced in other imaging applications with no limitation. Descriptions provided herein will enable a person of ordinary skill in the art of imaging processing to practice the various embodiments of the present invention in a wide range of imaging applications.

Further, various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation.

The phrase “in one embodiment” is used repeatedly. The phrase generally does not refer to the same embodiment; however, it may. The terms “comprising,” “having,” and “including” are synonymous, unless the context dictates otherwise. The phrase “A/B” means “A or B”. The phrase “A and/or B” means “(A), (B), or (A and B)”. The phrase “at least one of A, B and C” means “(A), (B), (C), (A and B), (A and C), (B and C) or (A, B and C)”. The phrase “(A) B” means “(B) or (A B)”, that is, A is optional.

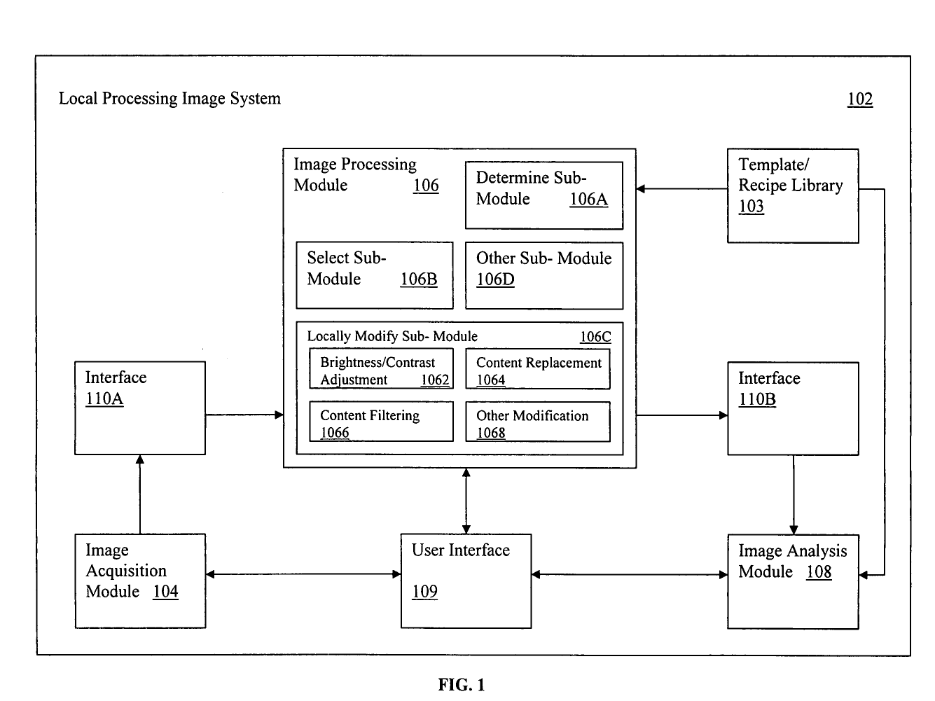

FIG. 1 illustrates modules in various embodiments of the present invention. As illustrated, an image processing module 106 may be included in a local processing image system 102, such as a CD-SEM system, and may be connected to an image acquisition module 104 capable of receiving images through an interface 110A, and may be connected to an image analysis module 108 capable of measuring all or a portion of the received image or images through an interface 110B. In various embodiments, the local processing image system 102 may further include one or more sub-modules of the image processing module 106, such as determine sub-module 106A, select sub-module 106B, locally modify sub-module 106C, and other sub-module 106D. Locally modify sub-module 106C may include brightness/contrast adjustment 1062, content replacement 1064, content filtering 1066, and other modification 1068. The local processing image system 102 may also include a template/recipe library 103 connected to the image processing module 106 and the image analysis module 108, and a user interface 109 connected to the image acquisition module 104, the image processing module 106, and the image analysis module 108. Also, in other embodiments not shown here, the image processing module 106 may be included in a special or general purpose computer device rather than included in an image processing system such as the local processing image system 102. The other device may or may not include the image acquisition module 104, the image analysis module 108, the interfaces 110A/110B, the template/recipe library 103 and the user interface 109.

Once an image has been received by the image acquisition module 104, the image processing module 106 may determine, through the determine sub-module 106A, one or more regions of the received image for modification, such as to remove information, through application of one or more criteria to the image; select, through the select sub-module 106B, one or more modifications to be made to the one or more determined regions of the image, including modifications to remove information, the one or more modifications associated with at least one of the one or more criteria; and locally modify, through locally modify sub-module 106C, the one or more determined regions of the image in accordance with the selected one or more modifications, including modifications to remove information. In various embodiments, the images may be received in digitized form. In other embodiments, the images may be received encoded in analog signals and converted to the digital form. Hereinafter, for ease of understanding, a digital representation of an image may be referred to as an image.

In some embodiments, the image acquisition module 104 may receive a plurality of acquired images of a portion or an entire field of view, each image capturing at least a portion of the field of view and taken under different conditions. Such images may be comparable to the determined regions described above, each capturing a portion of the whole, and at least one receiving some sort of modification. The modification may be selected by the image processing module 106 for at least one of the plurality of images. Upon selection, the image processing module 106 may modify the at least one of the plurality of images in accordance with the selected one or more modifications (including, for example, modifications to remove information), and combine the plurality of images taken under different conditions, modified and unmodified, to form a composite image. In various embodiments, the composite image may comprise the best images of each portion of the field of view taken under different conditions. What constitutes best may vary depending upon situation or application.

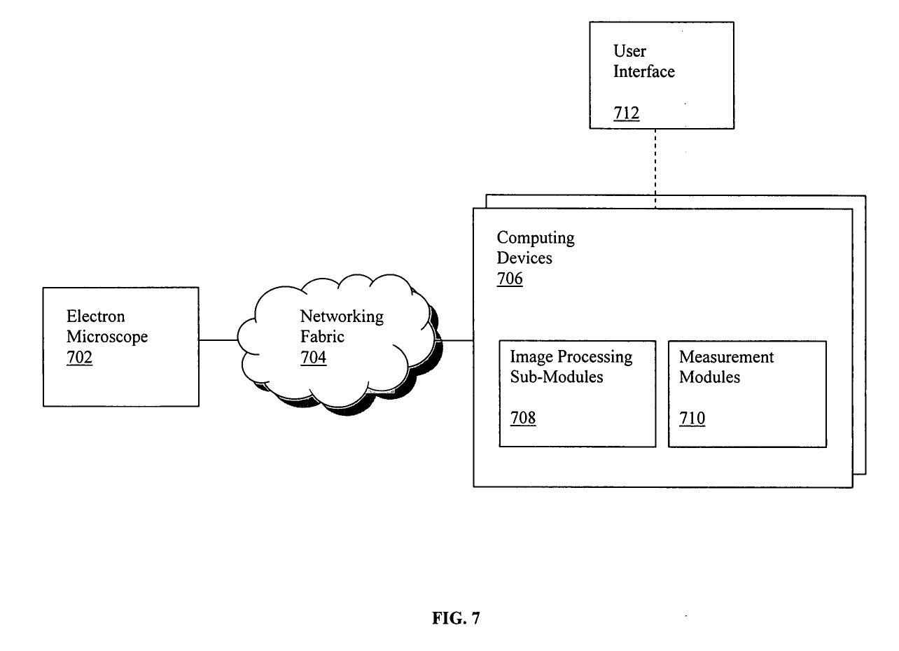

As alluded to earlier, the local processing image system 102 may further comprise a scanning electron microscope and one or more computing devices implementing some or all of the template/recipe library 103, the image acquisition module 104, the image processing module 106, the image analysis module 108, the user interface 109, and the interfaces 110A/110B. Some or all of the scanning electron microscope and the one or more computing devices may be networked, and still other components or modules may facilitate users in transferring images and data between the various scanning electron microscopes and devices of the local processing image system 102. The image processing module 106 and the image analysis module 108 may be an embedded part of one or more of the computing devices, allowing the local processing image system 102 to be enhanced to provide local image modifications of at least a part of the acquired image, including local image modification to remove information. Such embodiments operating as a part of the local processing image system 102 are described in greater detail below and are depicted in FIG. 7.

Alternatively, in other embodiments not shown, the image processing module 106 may be a component of one or more other computing devices. Computing devices which have an integrated image processing module 106 may include digital cameras, analog cameras, and video cameras. In addition, the computing devices may include special purpose electronic appliances such as mobile phones, both with and without integrated cameras, and Personal Digital Assistants (PDAs). However, embodiments of the present invention are not limited to any of the above devices, but rather may be used in conjunction with any computing device known in the art capable of image processing. Such a computing device may also include an image acquisition module 104 capable of receiving the image connected to the image processing module 106 through interface 110A. The computing device may acquire the image itself in any manner known in the art for that type of device, or may receive the image through the image acquisition module 104 or another module of the computing device. Furthermore, the computing device may contain one or more other modules to perform one or more other device functions, such as the image analysis module 108. The other modules may facilitate the device in performing any device function known in the art, such as displaying or printing the locally modified image.

In other embodiments, the local processing image system 102 or other device may directly or indirectly acquire or receive multiple images of a portion or an entire field of view, each image capturing at least a portion of the field of view and taken under different conditions. Such acquisition may involve the sequential capture of images by a detector or a sensor, such as a scanning electron microscope or a camera, or may involve the simultaneous capture of images by multiple modules of the local processing image system 102 or computing device.

The image processing module 106 may be connected to the image acquisition module 104 by an interface 110A and the image analysis module 108 by an interface 110B. The interfaces 110A/110B may be any sort of interfaces known in the art, such as wired or wireless networking interfaces, or a removable media drives. Further, the interfaces 110A/110B may receive an acquired image, either directly from another computer connected via a networking interface, or indirectly through a storage media. If networking interfaces, the interfaces 110A/110B may be any sort of networking interfaces known in the art, such as an Ethernet interface or a wireless interface, such as Bluetooth, Wi-Fi, WIMAX, or ZigBee. The interfaces 110A/110B may be any removable media interfaces adapted to accept one or more of a number of media types such as floppy diskettes, compact discs (CDs), thumb drives, and flash memory Universal Serial Bus (USB) sticks, but may be adapted to accept any media type known in the art. Upon receiving the image or images, the interface 110A may store the image or may call upon the image processing module 106 and pass the received image to the image processing module 106.

In other embodiments, the local processing image system 102 or the computing device need not have separate interfaces 110A/110B. In such embodiments, the image processing module 106 may be a part of the scanning electron microscope or the computing device with a camera lens. Upon acquiring the image, the microscope or lens may store the image for later use by the image processing module 106, or may call the image processing module 106 and pass the image to the image processing module 106.

In some embodiments, where the interface receives a single image, the image processing module 106 may determine, through its determine sub-module 106A, one or more regions of the image for modification, including modifications to remove information, through application of one of more criteria to the image. The one or more criteria may comprise any number of rules, models, or signatures applied by the image processing module 106 to the image in an automated fashion, requiring no user interaction. Example rules may include settings for brightness, contrast, saturation, or hue (color), determining regions around portions of the image either meeting or not meeting the settings. The settings might further comprise minimum and/or maximum values for the above determined regions where the brightness, contrast, saturation, or hue (color) exceed a maximum or fall below a minimum, what constitutes maximum and minimum varying depending upon situation or application. Additionally, a pattern, such as contents of a portion of the image, may be used to determine a region. For example, the pattern may be of a target object, and the image processing module 106 may compare the target object pattern to a template object pattern, determining a region for each portion of the image that matches. Further, the one or more criteria may also comprise any number of rules, models, or signatures, such as those found in template/recipe library 103. For example, the model might be a recipe of template/recipe library 103 for the target object, which looks for regions matching the template object in the template/recipe library 103. With each region investigated, the model may have an associated brightness, contrast, saturation, hue (color) that is utilized to determine the regions of the image.

Also, if the image is received or acquired by the local processing image system 102 having the image acquisition module 104 and the mage processing module 106, the local processing image system 102 may further provide a user interface 109 giving a user of the local processing image system 102 the option of determining the regions from which to remove information manually rather than having the image processing module 106 automatically determine the regions that match. Such a user interface 109 may or may not be a graphic user interface (GUI). Exemplary embodiments exhibiting this optional feature are discussed further below and are depicted by FIG. 7.

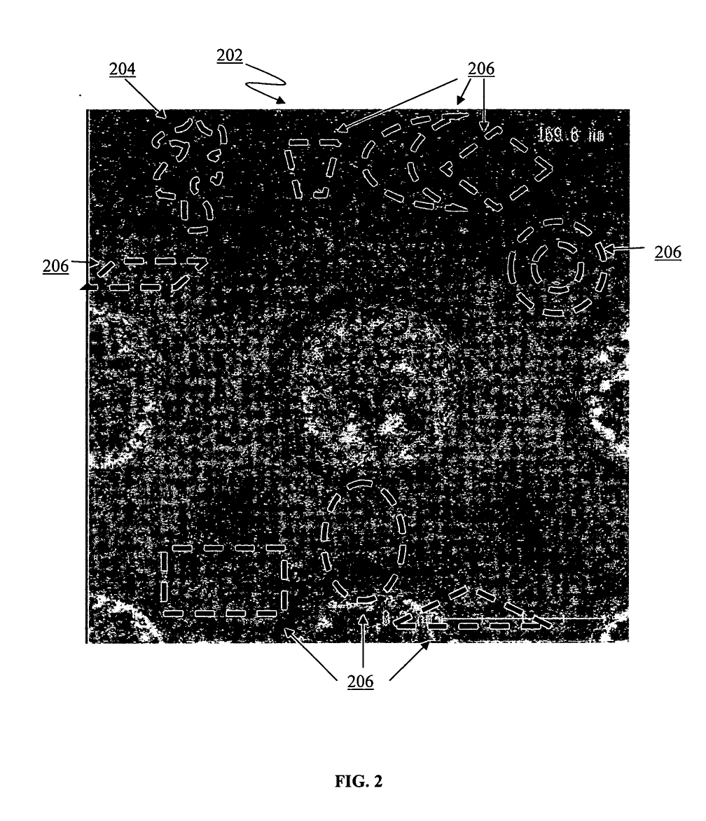

The image processing module 106 may also determine one or more image regions of any geometric or free-form shape through determine sub-module 106A. Such shapes are depicted in FIG. 2 and discussed below. Geometric shapes may include squares, rectangles, circles, ovals, triangles, parallelograms, trapezoids, polygons of any number of sides, stars, hearts, crescents, donuts, or any other geometric shape known in the art. Free-form shapes may not correspond to any common geometric shape, but may correspond strictly to the portions of the image matching the criteria, thus potentially creating a shape without a known geometric form. Geometric shapes may, however, correspond either approximately or exactly to the determined region, and even if approximately, may be used in place of the region if free-form shapes are found undesirable for some reason. Thus, the region to have a modification selected on its behalf may be either the exact determined region or an approximation of that region in a closely matching geometric shape.

In other embodiments, where image processing modules 106 process multiple images of a portion or an entire field of view, each image capturing at least a portion of the field of view and taken under different conditions, the multiple images may have any combination of differing resolutions (pixel sizes), magnifications (zooms), brightnesses, contrasts, saturations, hues (colors), or other image variations known in the art. By capturing multiple images having variations, these embodiments allow focus on different aspects of a field of view that may be advantageously modified differently. For example, background portions of the field of view that are further away may be taken at a different resolution or magnification (zoom) than portions in the foreground with multiple images, as it might be advantageous to enhance the brightness of images in the background and decrease the brightness of images in the foreground. Additionally, background portions of the image that may show items at a smaller and thus more pixilated resolution may be captured as an image having a greater magnification (zoom) than another image of portions of the field of view in the foreground showing items that are larger and not as pixilated.

Further, the multiple images may have one or more modifications, including modifications to remove information, selected by select module 106B for at least one of them based on the type of at least one of the multiple images or based on one or more other criteria. For example, if the image type is an image with a higher magnification (zoom), the selected modification may be to increase the image brightness. Additionally, any number of other criteria, such as those discussed above for determining regions of a single image, may also be used to select one or more modifications for at least one of the multiple images. Thus, rules, models, and signatures associated with settings or ranges for brightness, contrast, saturation, hue (color), or a pattern may be applied to at least one of the multiple images to determine, through determine sub-module 106A, a modification or modifications for that image or those images.

In various embodiments, the local modification made by the locally modify sub-module 106C of image processing module 106 to remove information may be one or more of brightness adjustment 1062, contrast adjustment 1062, content replacement 1064, and content filtering 1066. Brightness or contrast adjustments 1062 may increase or decrease the brightness or contrast of a determined region or of one of a plurality of images. Other modifications, such as content replacement 1064, may involve the image processing module 106 determining two regions of an image capturing the same or a similar object or object portion, exactly or approximately, one determined by the image processing module 106 to need modification, the other determined to provide that modification. In such embodiments, the image processing module 106 may copy the modification-providing region and paste the copied region over the modification-needing region, thus removing information from the modification-needing region. Such copying and pasting may be accomplished by the image processing module 106 in an automated fashion, not requiring interactions from users. Additionally, modifications such as content filtering 1066 may involve the image processing module 106 retrieving a second image similar to the determined region of the received image, in some embodiments from template/recipe library 103, the second image previously determined to be an accurate image of the determined region, not in need of modification, or already modified. Upon retrieving the second image, the image processing module 106 may compare the determined region to the second image, keeping portions of the determined region that match the second image and replacing portions that don't match with corresponding portions from the second image, thus removing information. In addition, any other modification 1068 known in the art of image processing may also be selected and made.

Brightness or contrast adjustments 1062 may, in some embodiments, comprise one or more of variable level adjustment, linear adjustment, inverse-linear adjustment, non-linear adjustment, and inverse non-linear adjustment. Variable level adjustment may simply involve determining one or more regions of an image based on one of the above criteria, and adjusting the brightness of the regions to remove information. Thus, regions may be of any shape and may be adjusted to any brightness or contrast without reference to the brightness or contrast of other portions of the image. Among other adjustments, linear adjustment may involve making all or some of the regions brighter by some linear factor. In contrast, inverse linear adjustment may involve determining a plurality of regions of an image by their brightness or contrast, and making the dark regions brighter and the bright regions darker by some linear factor. Further, non-linear adjustment may involve brightening regions initially determined to be brighter than other regions more than those other regions. In contrast, inverse non-linear adjustment may involve darkening regions initially determined to be brighter than other regions, and brightening those other regions initially determined to be darker, but not by the same factor that the brighter regions are being darkened.

Also, in other embodiments where the image processing module 106 processes multiple images of all or a portion of a field of view taken under different conditions, modification can be made to the brightness of at least some of the multiple images by passing one or more images through an image brightness filter (not shown), the image brightness filter implemented in some embodiments as an optical wavelength filter or intensity filter which may filter the high brightness signals of images passed through the filter, reducing the brightness of the images and removing information. Also, other similar hardware components known in the art and used in image processing may be used in place of or in conjunction with the image processing module 106 in modifying some or all of the images, including modification removing information.

In some embodiments, where the image processing module 106 receives and processes multiple images of portions or the whole of a field of view taken under different conditions, the image processing module 106 may then combine at least some of the multiple images, modified or unmodified, to form a composite image encompassing all or a portion of the field of view. The multiple images combined to form the composite image may be those considered by the image processing module 106 to be the best images of specific portions of the field of view, taken under different conditions. What constitutes a best image may vary depending upon situation or application, and may also be determined in accordance with the above criteria used to select modifications, or may be determined in accordance with other criteria that may be of use in image processing.

As is further shown, the image analysis module 108 may measure a feature of one or more of the modified or non-modified regions of the images, of the entire image, or of a composite image created from the plurality of images. Subsequent to modifying the image or images, the image processing module 106 may store the modified image or composite image or may call the image analysis module 108 and pass to the image analysis module 108 the modified image or composite image through interface 110B.

In other embodiments, the image processing module 106 may not be connected to the image analysis module 108. The image processing module 106 may instead be connected to some other module of a computing device to perform some other device function, such as displaying the image or printing the image. The image processing module 106, need not however, be connected to another sort of module, such as the image analysis module 108.

FIG. 2 illustrates an exemplary image of contact holes suitable for use by various embodiments of the present invention, as well as a plurality of regions of that image. As illustrated, image 202 may be considered as having a plurality of regions, such as the free-form shaped region 204, and the geometric shaped regions 206. The geometric shaped regions 206 may include rectangle, oval, triangle, parallelogram, trapezoid, crescent, diamond, and donut shaped regions, as shown, but may include any geometric shape known in the art. Free-form shapes, such as shape 204, may not correspond to any common geometric shape, but may correspond strictly to the portions of the image 202 matching one or more criteria, thus potentially creating a shape without a known geometric form. Geometric shapes 206 may, however, correspond either approximately or exactly to the determined region, and even if approximately, may be used in place of the region if free-form shapes 204 are found undesirable. Thus, the region to have a modification selected on its behalf may be either the exact determined region or an approximation of that region in a closely matching geometric shape. As will be described in more detail below, the regions may be selected based on a number of criteria or by a user, including criteria directed toward removing information from the image. The criteria may include but are not limited to brightness, contrast, saturation, hue (color), or pattern of the various regions of the image, standalone or relative to one another or to the overall image or other reference image or images.

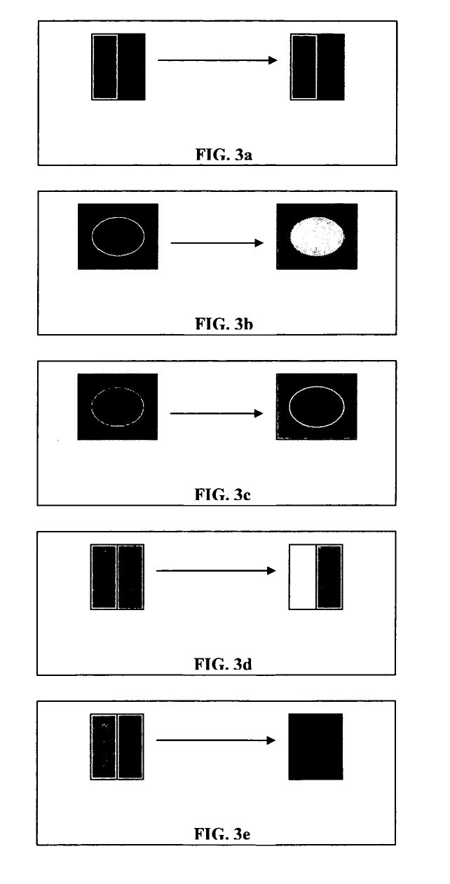

FIGS. 3a-3e illustrate exemplary brightness and contrast modifications 1062 performed on selected regions of an image by various embodiments of the present invention. Brightness or contrast adjustments may, in some embodiments, comprise one or more of variable level adjustment, linear adjustment, inverse-linear adjustment, non-linear adjustment, and inverse non-linear adjustment, the adjustments capable of removing information.

Variable level adjustment, depicted in FIG. 3a, may involve adjusting the brightness of the selected regions. As described earlier, regions may be of any shape. In various embodiments, the selected regions may be adjusted to any brightness or contrast without reference to the brightness or contrast of other portions of the image. For the exemplary regions illustrated in FIG. 3a, only the region comprising the right side of the depicted image has had its brightness adjusted by darkening the region.

Among other adjustments, linear adjustment, depicted in FIG. 3b, may involve making all or some of the regions brighter by some linear factor. For the exemplary regions illustrated in FIG. 3b, both regions shown have been brightened by the same linear factor.

In contrast, inverse linear adjustment, depicted in FIG. 3c, may involve making the dark ones of the selected regions brighter or the brighter ones of the selected regions darker by some linear factor. For the exemplary regions illustrated in FIG. 3c, as shown, the bright region of the image has been made darker, and the dark brighter, both by the same linear factor. In alternate embodiments, the regions may be adjusted by different linear factors. In other embodiments, one of the linear factor may be “1” (denoting unchanged), resulting in the region not getting adjusted relative to the other regions getting adjusted.

In still other embodiments, non-linear adjustment may be performed, as depicted in FIG. 3d. In various embodiments, non-linear adjustments may involve brightening regions initially determined to be brighter than other regions more than those other regions. For the exemplary regions illustrated in FIG. 3d, the initially brighter region on the left has been made brighter by a greater factor than the initially darker region, though both regions have been made brighter.

In contrast, in other embodiments, inverse non-linear adjustment may be performed, as depicted in FIG. 3e. In various embodiments, inverse non-linear adjustment may involve darkening regions initially determined to be brighter than other regions, and brightening those other regions, but not to the same linear factor that the brighter regions are being darkened. For the exemplary regions illustrated in FIG. 3e, the initially brighter region on the left has been made darker by a greater factor than the initially darker region has been made brighter.

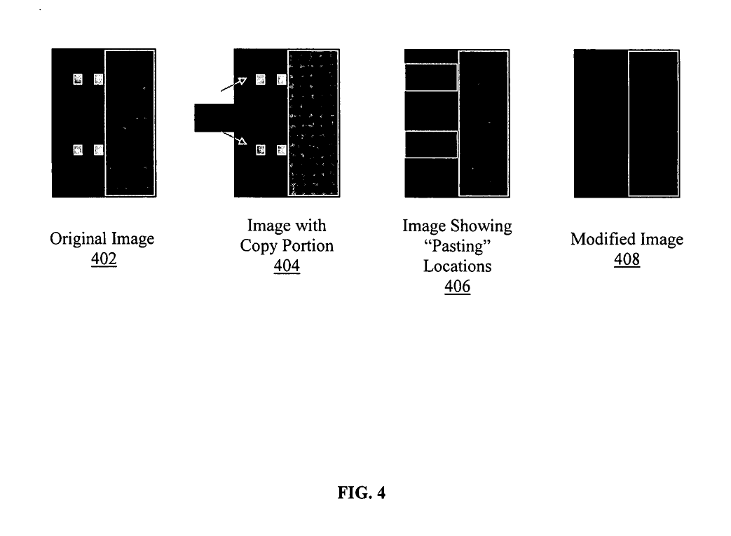

FIG. 4 illustrates an exemplary content replacement modification 1064 performed on selected regions by various embodiments of the present invention. As illustrated, an original image 402 may have a region of image content replaced with another region of image content, the second region being the copy portion that is copied and pasted onto the replaced portion, thus removing information. This may involve module 106 determining two or more regions of an image, such as image 402, capturing the same or a similar object or object portion, exactly or approximately, one determined by the module 106 to need modification, including the removal of information, the other determined to provide that modification. For the exemplary regions illustrated in FIG. 4, the copy portion depicted with the image, picture 404, may serve as the portion providing the modification. Also illustrated are two regions/portions needing modification, these regions pointed to by arrows, picture 404. The image processing module 106 may then copy the modification-providing region (copy portion) and paste the copy portion over the modification-needing region or regions, picture 406. Upon completion of the pasting, a modified region and/or image results, such as modified image 408. Such copying and pasting may be accomplished by module 106 in an automated fashion, not requiring interactions from users. However, in alternate embodiments where module 106 are a part of a local processing image system 102, and image 402 is a CD-SEM system image, the CD-SEM system, in addition to making the steps of identifying both the modification-needing region or regions, and pasting the copy portion over the modification needing region(s), all automatically, may also provide an optional user interface to allow CD-SEM system users to determine the portions needing replacement and the copy portion. Such embodiments are described further below.

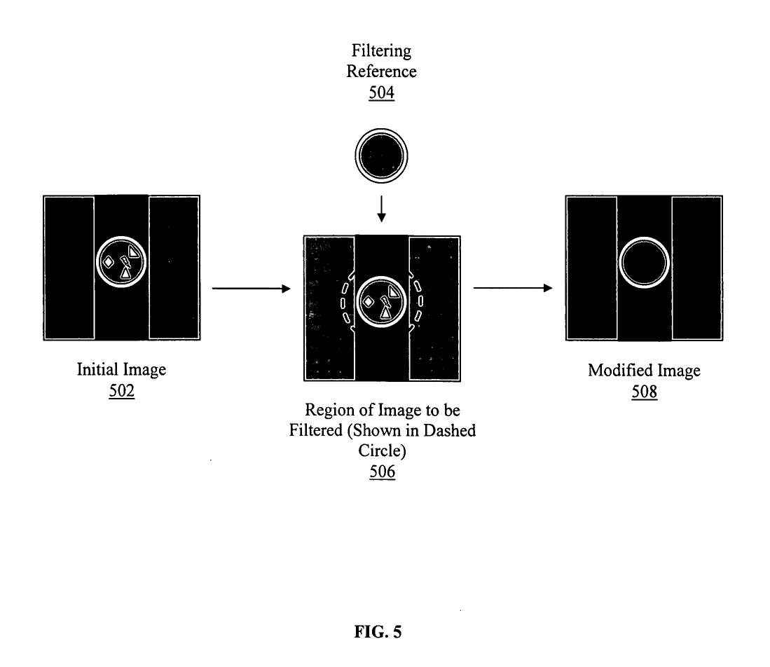

FIG. 5 illustrates an exemplary content filtering modification 1066 performed on selected regions by various embodiments of the present invention. As illustrated, an initial image 502 may have a region of image content filtered against a second image to produce a modified image 508 having information removed, the modified image 508 having the region of image content that was filtered being identical to the second image. For the exemplary region illustrated in FIG. 5, the second image is depicted as filtering reference 504. The filtering reference 504 may be similar to the determined region of the initial image 502 needing filtering, here depicted, picture 506, and may, in some embodiments, be found in a template/recipe library 103. Further, the filtering reference 504 may have been previously determined to be an accurate image of the determined region, picture 506, not in need of modification, or already modified. Filtering reference 504 may be an image retrieved from the same device as image processing module 106, or from a separate device. The filtering reference 504 may have the same shape as the portion of the image that is to be filtered, but its size may be different from that portion. Upon retrieving the filtering reference 504, module 106 may compare the determined region to the filtering reference 504, keeping portions of the determined region that match the filtering image 504 and replacing portions that don't match with corresponding portions from the filtering reference 504. Upon completion, a modified image 508 is produced with information removed.

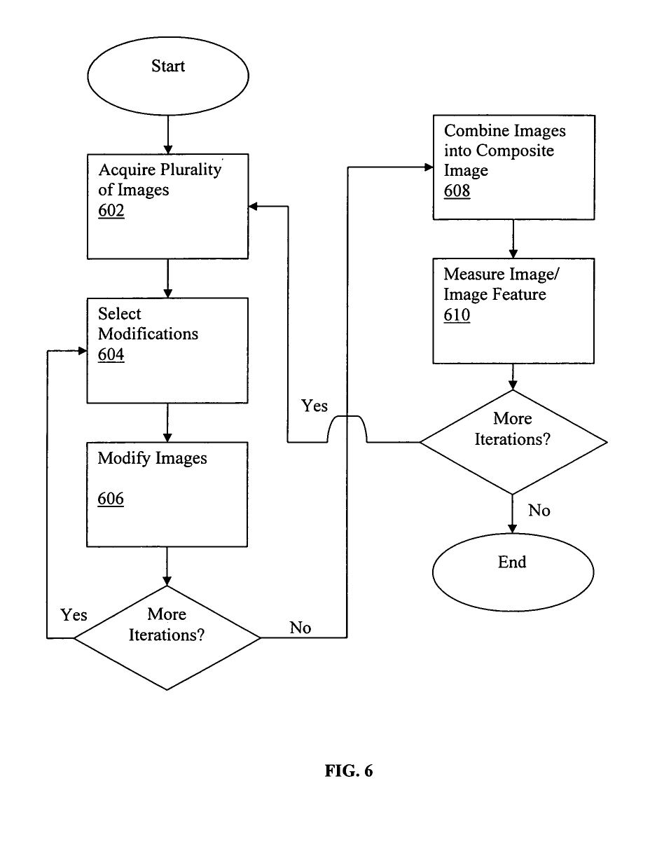

FIG. 6 illustrates a flow chart view of selected operations of the methods of various embodiments of the present invention. As illustrated, a method of one of the various embodiments may first comprise acquiring a plurality of images, block 602. Such images may be sequentially or simultaneously acquired by one or more CD-SEM system scanning electron microscopes, camera lenses, or other image capturing devices known in the art. The multiple images may be of all or just a portion of a field of view, each image capturing at least a portion of the field of view and taken under different conditions.

In some embodiments, the multiple images may have any combination of differing resolutions (pixel sizes), magnifications (zooms), brightnesses, contrasts, saturations, hues (colors), or other image variations known in the art. By capturing multiple images having variations under different conditions, block 602, these embodiments allow focus on different aspects of a field of view that may be advantageously modified differently. For example, background portions of the field of view that are further away may be taken at different resolution or magnification (zoom) than portions in the foreground with multiple images, as it might be advantageous to enhance the brightness of images in the background and decrease the brightness of images in the foreground.

Upon acquiring the plurality of images, a method of an embodiment may select one or more modifications for at least one of the plurality of images, including modifications removing information, block 604. The one or more modifications selected for at least one of the multiple images may be based on the type of at least one of the multiple images or based on one or more other criteria. For example, if the image type is an image with a higher magnification (zoom), the selected modification may be to increase the image brightness. Additionally, any number of other criteria, such as the rules, models, and signatures discussed above in reference to FIG. 1, may also be used to select one or more modifications for at least one of the multiple images. Thus, rules, models, and signatures associated with settings or ranges for brightness, contrast, saturation, hue (color), or a pattern may be applied to at least one of the multiple images to determine a modification or modifications for that image or those images.

In various embodiments, the modification may be one or more of brightness adjustment, contrast adjustment, content replacement, and content filtering directed towards removing information. Brightness and/or contrast adjustments may increase or decrease the brightness or contrast of one or more of a plurality of images. Brightness or contrast adjustments may comprise one or more of variable level adjustment, linear adjustment, inverse-linear adjustment, non-linear adjustment, and inverse non-linear adjustment, these types of adjustments described in greater detail above in reference to FIG. 3. Other modifications, such as content replacement, may involve determining two images capturing the same or a similar object or object portion, exactly or approximately, one determined to need modification, including the removal of information, the other determined to provide that modification. Such a modification may be made to an image, block 606, by replacing the modification-needing image with the modification-providing image. Additionally, modifications such as content filtering may involve retrieving a second image similar to a first image needing modification, the second image previously determined to be an accurate image of the portion of the field of view captured by the first image. Upon retrieving the second image, the first image may be compared to the second image, keeping portions of first image that match the second image and replacing portions that don't with corresponding portions from the second image, thus removing information. In addition, any other modification known in the art of image processing may also be selected and made.

Also, modification can be made to the brightness of at least some of the multiple images by passing one or more images through an image brightness filter, the image brightness filter implemented in some embodiments as an optical wavelength filter or intensity filter which may filter the high brightness signals of images passed through the filter, reducing the brightness of the images and removing information. Also, other similar hardware components known in the art and used in image processing may be used in modifying some or all of the images.

As is further shown, upon selecting the one or more modifications described above, a method of an embodiment may modify one or more of the images, block 606. Such modification may simply involve applying the above modifications in the manner described above, generating one or more modified images. In some embodiments, a method may then determine if there are more images in need of modifications. If there are more images, the method may select one or more modifications, block 604, for the images, and modify the images, block 606.

In some embodiments, upon modifying the images, block 606, methods of an embodiment may then combine some of the multiple images, modified or unmodified, to form a composite image encompassing all or a portion of the field of view, block 608. The multiple images combined to form the composite image may be those considered to be the best images of specific portions of the field of view taken under different conditions. What constitutes a best image may vary depending upon situation or application, and may also be determined in accordance with the above criteria used to select modifications, or may be determined in accordance with other criteria that may be of use in image processing.

As is further shown, methods of an embodiment may then measure a feature of one or more of the modified or non-modified images or of a composite image created from the plurality of images, block 610.

Upon completion, of the above selected operations, a method may repeat the operations for other acquired images.

FIG. 7 illustrates a CD-SEM system view of embodiments of the present invention. As illustrated, a CD-SEM system such as local processing image system 102 may comprise an electron microscope 702 capable of capturing multiple images, one or more computing devices 706 coupled to the electron microscope 702, in some embodiments connected via a networking fabric 704. The one or more computing devices 706 may have embedded, within at least one of the computing devices, one or more image processing sub-modules 708 adapted to determine one or more regions of at least one image captured by the electron microscope 702, select one or more modifications to be made to at least one of the one or more regions of the image, including modifications to remove information, and locally modify at least one of the one or more regions of the image in accordance with the selected one or more modifications. Further, as shown, at least one of the computing devices 706 may have coupled to it one or more modules 710 adapted to measure the locally modified image. To facilitate a CD-SEM system user in determining regions to modify and in selecting modifications, computing devices 706 may also provide an optional user interface 712, which in some embodiments may be a graphic user interface.

In some embodiments, the CD-SEM system may comprise an electron microscope 702 and one or more computing devices 706 connected by a networking fabric 704. Networking fabric 704 may be wired or wireless, and may represent a local area network (LAN) or a wide area network (WAN). Additionally, networking fabric 704 may utilize any sort of connections known in the art, such as transmission control protocol/internet protocol (TCP/IP) connections or asynchronous transfer mode (ATM) virtual connections, among many others. Such a networking fabric may transfer the image or images acquired by microscope 702 to devices 706 for image processing and measurement.

In other embodiments, not shown, microscope 702 and computing devices 706 may have no persistent connection at all, and may instead rely on removable media interfaces facilitating CD-SEM system users in transferring the images from the microscope 702 to the devices 706. Such removable media interfaces may support one or more of floppy disks, CDs, and/or thumb drives, or any other media devices known in the art capable of having CD-SEM images written to and read from them.

In yet other embodiments, not shown, electron microscope 702 and computing device 706 are the same physical device. In such embodiments no transfer of the acquired images would be necessary. Upon acquisition, images may simply be stored in image storage of microscope/device 702/706, or may be passed directly to image processing sub-modules 708 by calling such modules. Such embodiments may further comprise a display screen (not shown) for displaying the initially acquired and/or modified images.

As shown, the electron microscope 702 may be any sort of electron microscope known and used in the art, and may be comprised of such components as an electron gun, a column, a sample chamber, ion pumps, a power source, secondary electron detectors, scan generators, and image memory. Such components may perform their usual functions, enabling the electron microscope 702 to scan a feature/region of a circuit or device with a beam of electrons and to measure the secondary electrons given of by the scanned feature/region when hit by the beam of electrons, creating an image of the feature/region from the secondary electron measurements. Additionally, in some embodiments where the electron microscope 702 and the device 706 are the same physical device, the electron microscope 702 may further comprise image processing sub-modules 708 and measurement modules 710, image processing sub-modules 708 and modules 710 to be discussed in greater detail below. Also, such an electron microscope 702 may be coupled to a display screen (not shown) for displaying the initially acquired or modified images. Electron microscopes are well known in the art however, and thus will not be described further.

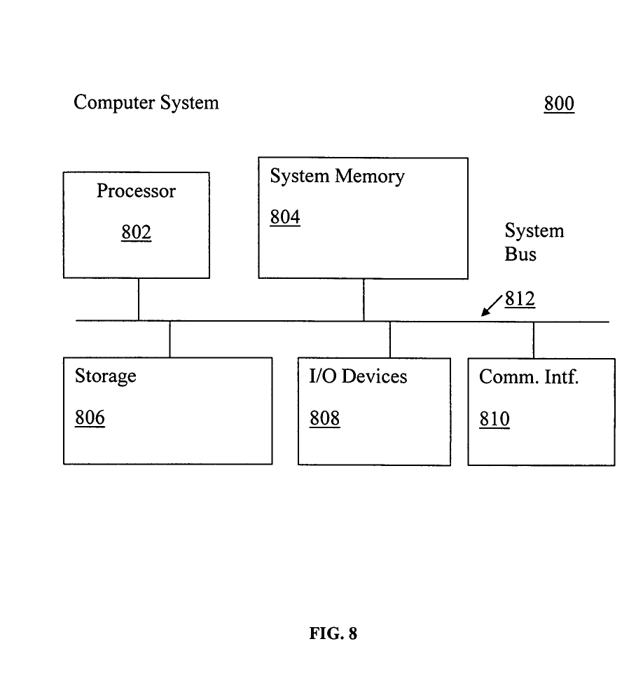

As is further illustrated, computing devices 706 may be any sort of computing device known in the art capable of processing and measuring one or more CD-SEM images. Such computing devices may include workstations, servers, PCs, mainframes, and many others. Such a computing device is depicted by FIG. 8 and described in greater detail below. Coupled to computing device 706 may be at least one display screen adapted to display CD-SEM images, before or after modification, and optional user interface 712. Computing device 706 may further comprise one or more image processing sub-modules 708, as well as measurement modules 710. In some embodiments, computing device 706 and electron microscope 702 may be the same physical device.

In some embodiments, image processing sub-modules 708 (shown in FIG. 7) may be identical to module 106 (shown in FIG. 1), and are described further above in reference to image processing module 106. Criteria that may be used to determine the one or more regions, such as image brightness, contrast, saturation, hue (color), or a pattern, have been described in reference to module 106, as are modifications that may be selected to be made to the one or more regions to remove information, such as brightness/contrast adjustments, content replacement, and content filtering. Further, as described above, brightness contrast adjustments may comprise one or more of variable level adjustments, linear adjustments, non-linear adjustments, inverse linear adjustments, and inverse non-linear adjustments.

Additionally, image processing sub-modules 708 may facilitate a CD-SEM system user in determining the one or more regions of the image or in selecting the one or more modifications to remove information, in some embodiments by providing an optional user interface 712. Optional user interface 712 may be a graphic user interface (GUI), a command line interface, or any other sort of user interface known in the art capable of information display and user interaction facilitation. User interface 712 may be used in addition to the automated processes of sub-modules 708, or may replace one or more of the processes, such as region determining, requiring a CD-SEM user to use user interface 712 to, for example, determine the one or more regions.

As shown, measurement modules 710 may be adapted to measure a feature of one or more of the modified or non-modified regions of the image or of an entire image. Subsequent to modifying the image or images, sub-modules 708 may store the modified image(s) or may call measurement modules 710 and pass modules 710 the modified image(s).

Additionally, image processing sub-modules 708 may buffer the original received image, and upon measurement of the desired feature of the modified image, may overlay traces of the measurement on the original image, displaying the measurement with that original image. Thus, the advantages of having an accurate measurement and the original image displayed together are obtained.

FIG. 8 illustrates an example computer system suitable for use to practice various embodiments of the present invention. As shown, computer system 800 includes one or more processors 802 and system memory 804. Additionally, computer system 800 may include input/output devices 808 (such as keyboard, cursor control, and so forth). The elements are coupled to each other via system bus 812, which represents one or more buses. In the case of multiple buses, they are bridged by one or more bus bridges (not shown). Each of these elements performs its conventional functions known in the art. In particular, system memory 804 and storage 806 are employed to store programming modules adapted to perform the local image processing and measuring aspects of embodiments of the present invention, and a permanent copy of the programming instructions implementing the programming modules adapted to perform the local image processing and/or measuring aspects of embodiments of the present invention, respectively (or subsets of these functions). The permanent copy of the instructions implementing the programming modules adapted to perform the local image processing and measuring aspects of embodiments of the present invention (or subsets thereof) may be loaded into storage 806 in the factory, or in the field, through a distribution medium (not shown) or through communication interface 810 which may or may not be identical to the interface for the local processing image system 102 (shown in FIG. 1) (e.g., from a distribution server). The constitution of these elements 802-812 are known, and accordingly will not be further described.

Although specific embodiments have been illustrated and described herein, it will be appreciated by those of ordinary skill in the art that a wide variety of alternate or equivalent implementations may be substituted for the specific embodiments shown and described, without departing from the scope of the embodiments. This application is intended to cover any adaptations or variations of the embodiments discussed herein. Therefore, it is manifestly intended that the embodiments of the present invention be limited only by the claims and the equivalents thereof.

What is claimed is:

1. An apparatus comprising:
an image acquisition module to receive an image;
an image processing module connected to the image acquisition module, the image processing module to process the image, comprising:
a first sub-module to determine one or more regions of the image for modification to remove information from the one or more regions, through application of one or more criteria to the image;
a second sub-module to select one or more modifications to be made to the one or more determined regions of the image to remove information from the one or more determined regions, the one or more modifications associated with at least one of the one or more criteria; and
a third sub-module to locally modify the one or more regions of the image in accordance with the selected one or more modifications to remove information from the one or more determined regions; and
an image analysis module connected to the image processing module, the image analysis module to measure the one or more regions.

2. The apparatus of claim 1, wherein the apparatus further includes a storage medium storing a plurality of programming instructions implementing the one or more modules, and a processor adapted to operate at least one of the one or more modules.

3. The apparatus of claim 1, wherein the one or more modifications to be made to the one or more determined regions of the image include content filtering to remove one or more content objects.

4. The apparatus of claim 1, wherein the image is a critical dimension scanning electron microscopy image captured by an electron microscope.

5. The apparatus of claim 1, wherein the one or more criteria for determining one or more regions of the image include at least one of brightness, contrast, saturation, hue (color), and a pattern.

6. The apparatus of claim 1, wherein the one or more modifications to be made to the one or more determined regions of the image include at least one of brightness adjustment, contrast adjustment, and content replacement.

7. The apparatus of claim 6, wherein the brightness and/or contrast adjustments are one of a variable level adjustment, a linear adjustment, a non-linear adjustment, an inverse linear adjustment, and an inverse non-linear adjustment.

8. The apparatus of claim 1, wherein the apparatus further comprises an additional one or more modules adapted to measure a portion of the one or more modified or non-modified regions of the image.

9. The apparatus of claim 1, wherein the one or more determined regions may be any common geometric shape, or may be of a free-form shape.

10. An article of manufacture comprising:
a machine-readable medium comprising a plurality of programming instructions stored therein, the plurality of programming instructions adapted to program an apparatus to enable the apparatus to
determine one or more regions of an image for modification to remove information from the one or more regions, through application of one or more criteria to the image;
select one or more modifications to be made to the one or more determined regions of the image to remove information from the one or more determined regions, the one or more modifications associated with at least one of the one or more criteria; and
locally modify the one or more regions of the image in accordance with the selected one or more modifications to remove information from the one or more one or more determined regions.

11. The article of claim 10, wherein the programming instructions are further adapted to program an apparatus to enable the apparatus to determine one or more regions of an image for modification to remove information, and the image is a critical dimension scanning electron microscopy image captured by an electron microscope.

12. The article of claim 10, wherein the programming instructions are further adapted to program an apparatus to enable the apparatus to determine one or more regions of an image for modification to remove information, through application of one or more criteria to the image, and the one or more criteria include at least one of brightness, contrast, saturation, hue (color), and a pattern.

13. The article of claim 10, wherein the programming instructions are further adapted to program an apparatus to enable the apparatus to select one or more modifications to be made to the one or more determined regions of the image to remove information, and the one or more modifications include content filtering.

14. The article of claim 13, wherein the one or more modifications further comprise brightness and/or contrast adjustment, and the brightness and/or contrast adjustments are one of a variable level adjustment, a linear adjustment, a non-linear adjustment, an inverse linear adjustment, and an inverse non-linear adjustment.

15. The article of claim 10, wherein the programming instructions are further adapted to program an apparatus to enable the apparatus to measure a portion of the one or more modified or non-modified regions of the image.

16. The article of claim 10, wherein the programming instructions are further adapted to program an apparatus to enable the apparatus to determine one or more regions of an image for modification to remove information, and the one or more regions may be any common geometric shape, or may be of a free-form shape.

17. A method comprising:
acquiring a plurality of images of a portion or an entire field of view, each image capturing at least a portion of the field of view, and taken under different conditions;
selecting one or more modifications for at least one of the plurality of images;
modifying at least one of the plurality of images in accordance with the selected one or more modifications; and
combining the plurality of images, modified and unmodified, to form a composite image.

18. The method of claim 17, wherein acquiring the plurality of image comprises acquiring a plurality of critical dimension scanning electron microscopy images captured by an electron microscope under different conditions.

19. The method of claim 17, wherein acquiring the plurality of image comprises acquiring a plurality of images having at least one of differing resolutions, differing zooms, differing brightnesses, and differing contrasts.

20. The method of claim 17, wherein selecting one or more modifications comprises selecting the one or more modifications based on the type of at least one of the plurality of images, or based on one or more other criteria.

21. The method of claim 20, wherein the one or more modifications are one or more of brightness adjustment, contrast adjustment, content replacement, and content filtering.

22. The method of claim 21, wherein the brightness and/or contrast adjustments are one of a variable level adjustment, a linear adjustment, a non-linear adjustment, an inverse linear adjustment, and an inverse non-linear adjustment.

23. The method of claim 17, further comprising measuring a portion of one or more of the plurality of images or of the composite image.

24. A local processing image system comprising:
a scanning electron microscope capable of capturing multiple images;
one or more computing devices coupled to the scanning electron microscope;
one or more sub-modules embedded within at least one of the one or more computing devices, the one or more sub-modules adapted to
determine one or more regions of at least one image captured by the electron microscope for modification to remove information,
select one or more modifications to be made to at least one of the one or more determined regions of the image to remove information, and
locally modify at least one of the one or more determined regions of the image in accordance with the selected one or more modifications to remove information; and
one or more modules connected to at least one of the one or more computing devices, the one or more modules adapted to measure the locally modified image.

25. The system of claim 24, wherein the one or more sub-modules are further adapted to facilitate a CD-SEM user in determining the one or more regions of the at least one image.

26. The system of claim 24, wherein the one or more sub-modules are further adapted to facilitate a CD-SEM user in selecting the one or more modifications to be made.

27. The system of claim 24, wherein the one or more criteria for determining one or more regions of the image include at least one of brightness, contrast, saturation, hue (color), and a pattern.

28. The system of claim 24, wherein the one or more modifications to be made to the one or more determined regions of the image include content filtering.

29. The system of claim 24, wherein the one or more modifications further comprise brightness and/or contrast adjustment, and the brightness and/or contrast adjustments are one of a variable level adjustment, a linear adjustment, a non-linear adjustment, an inverse linear adjustment, and an inverse non-linear adjustment.
